(19) United States
(12) Patent Application Publication
(10) Pub. No.: US 2011/0109798 A1
(43) Pub. Date: May 12, 2011

(54) METHOD AND SYSTEM FOR SIMULTANEOUS RENDERING OF MULTIPLE MULTI-MEDIA PRESENTATIONS

(76) Inventor: Alan R. McReynolds, Los Alto, CA (US)

(21) Appl. No.: 13/002,965

(22) PCT Filed: Jul. 9, 2008
(86) PCT No.: PCT/US08/08406

§ 371 Date: Jan. 6, 2011

(51) Int. Cl. H04N 7/00

(52) U.S. Cl. 348/485; 348/E07.001

(57) ABSTRACT

Embodiments of the present invention include methods and systems for simultaneous rendering of multiple multi-media presentations, including videos, which include both video or graphics signals that are rendered for visual display as well as audio signals that are broadcast through loudspeakers. In certain embodiments of the present invention, each video signal of a set of simultaneously displayed videos is rendered by a processing component for visual display within a separate video-display frame at a location on the screen of a visual-display device different from the locations of other video-display frames. The audio signal of each video is processed by the processing component to generate a spatial-audio signal that is perceived, by a user or viewer, to emanate from a position in space corresponding to the location of the video-display frame in which the video signal is rendered.

### TECHNICAL FIELD

The present invention is related to rendering multi-media presentations by a computer system or specialized data-rendering device, and, in particular, to a method and system for simultaneous rendering of multiple multi-media presentations.

### BACKGROUND OF THE INVENTION

Until the mid 1980's, digitally-encoded data was generally rendered on computer systems as character strings displayed on 24-line terminals or sheets of alphanumeric print outs. With the advent of the personal computer (“PC”) and low-cost workstations, users quickly began to demand more flexible display of information, using graphics, color graphics, animation, sound, video, and multi-media presentations combining sound and video. This demand was answered by rapid development of more capable visual display devices, including high-resolution color monitors, addition of loudspeakers to PCs and workstations, and development of graphics processing units and specialized graphics busses to create subsystems that provide vastly more powerful graphics-rendering and video-rendering capabilities to PCs and workstations. Popularization and commercialization of the Internet further increased demands for high-quality, computationally efficient multi-media presentation rendering capabilities.

A modern PC or workstation can generally render three-dimensional graphics in real time and display multiple video streams simultaneously. These capabilities have, in turn, facilitated and motivated increasingly capable multi-media applications, including powerful video-editing, video-searching, and video-rendering applications. However, although capabilities for rendering digitally-encoded data for visual display have continued to increase with each new generation of PCs and workstations, audio-rendering capabilities of PCs and workstations have remained relatively static. Most PCs and workstations provide audio cards for rendering audio data files into familiar left/right stereo signals that are broadcast through a pair of loudspeakers. The increasing disparity between the visual-rendering and the audio-rendering capabilities of modern PCs and workstations can result in constraints and deficiencies in applications that render multi-media presentations, including video presentations, which include both video and/or graphics as well as audio signals. For this reason, designers, developers, and vendors of a variety of multi-media-rendering applications and systems have all recognized the need for increasing the capabilities of PCs and workstations for rendering digitally-encoded audio data, and using these increased capabilities in combination with the already highly capable graphics-rendering and video-rendering systems to further increase the overall capabilities and features of various multi-media-rendering applications and devices.

### SUMMARY OF THE INVENTION

Embodiments of the present invention include methods and systems for simultaneous rendering of multiple multi-media presentations, including videos, which include both video or graphics signals that are rendered for visual display as well as audio signals that are broadcast through loudspeakers. In certain embodiments of the present invention, each video signal of a set of simultaneously displayed videos is rendered by a processing component for visual display within a separate video-display frame at a location on the screen of a visual-display device different from the locations of other video-display frames. The audio signal of each video is processed by the processing component to generate a spatial-audio signal that is perceived, by a user or viewer, to emanate from a position in space corresponding to the location of the video-display frame in which the video signal is rendered. Thus, a viewer perceives both the rendered video signal and the rendered audio signal of each video of a set of multiple, simultaneously displayed videos as emanating from a spatial position different from the spatial positions at which the rendered video and audio signals of the other videos are perceived to emanate. By processing the audio signals to generate spatial audio signals, method and system embodiments of the present invention facilitate the ability of a user or viewer to differentiate rendered component audio signals within a combined audio signal and to correlate each rendered component audio signal with a corresponding video-display frame and displayed video.

### BRIEF DESCRIPTION OF THE DRAWINGS

FIG. 1 illustrates a conventional display subsystem provided by a PC or work station.

FIG. 2 illustrates rendering, to a user or viewer, a single video data stream on the display subsystem shown in FIG. 1.

FIG. 3 illustrates simultaneous rendering of six different video data streams on the display subsystem shown in FIG. 1.

FIG. 4 illustrates rendering of the combined stereo audio signals of six simultaneously rendered video data streams on the display subsystem shown in FIG. 1.

FIG. 5 illustrates simultaneous rendering of multiple video data streams, according to one embodiment of the present invention, on the display subsystem shown in FIG. 1.

FIG. 6 shows a coordinate system often employed in audio-spatialization-related literature.

FIG. 7 illustrates azimuth-angle-related audio cues that facilitate determination, by human listeners, of the azimuth angle of a sound source.

FIG. 8 illustrates one source of elevation-angle-related audio cues that allow a human listener to determine the elevation angle of a sound source.

FIG. 9 illustrates range-related audio cues that allow a listener to determine the distance to a sound source.

FIG. 10 illustrates spatial transformation of a monaural audio signal to produce left and right signals that, when rendered through headphone speakers, is perceived by a listener to emanate from a selected point in three-dimensional space.

FIG. 11 provides a control-flow diagram for a simultaneous-video-data-stream-rendering routine that represents one embodiment of the present invention.

### DETAILED DESCRIPTION OF THE INVENTION

Embodiments of the present invention are directed to methods and systems for simultaneous rendering of multiple multi-media presentations, including videos, which include both graphical or video signals as well as audio signals. While the described embodiments are directed to simultaneous rendering of multiple video data streams, method and system embodiments of the present invention can be employed to simultaneously render any number of different types of multi-media data streams which include an audio signal and one or more additional signals, one of which is visually displayed. Video data streams are chosen for the described embodiments because of their familiarity to computer users and users of home-entertainment systems and ease of illustration.

A video data stream generally includes a digitally encoded video signal and a digitally encoded audio signal. Normally, a video data stream is compressed by various well-known compression techniques to produce a compressed video data stream. Rendering of compressed video data streams involves decompression, transformation of the decompressed video and audio signals to corresponding video and audio signals that can be received and rendered by system display and broadcast components, and routing of the transformed signals to system components for rendering to users or viewers. The video signal of a video data stream generally comprises a sequence of video frames that are displayed at a fixed interval in time, generally 1/30^{th} of a second. The audio signal of a video data stream is generally a digitally encoded discrete sampling of a complex, continuous signal at a very short, fixed time interval, or sampling rate. The digitally encoded audio signal is generally transformed back to a continuous, analog electrical signal that drives mechanical movement of the diaphragm of an electromechanical loudspeaker.

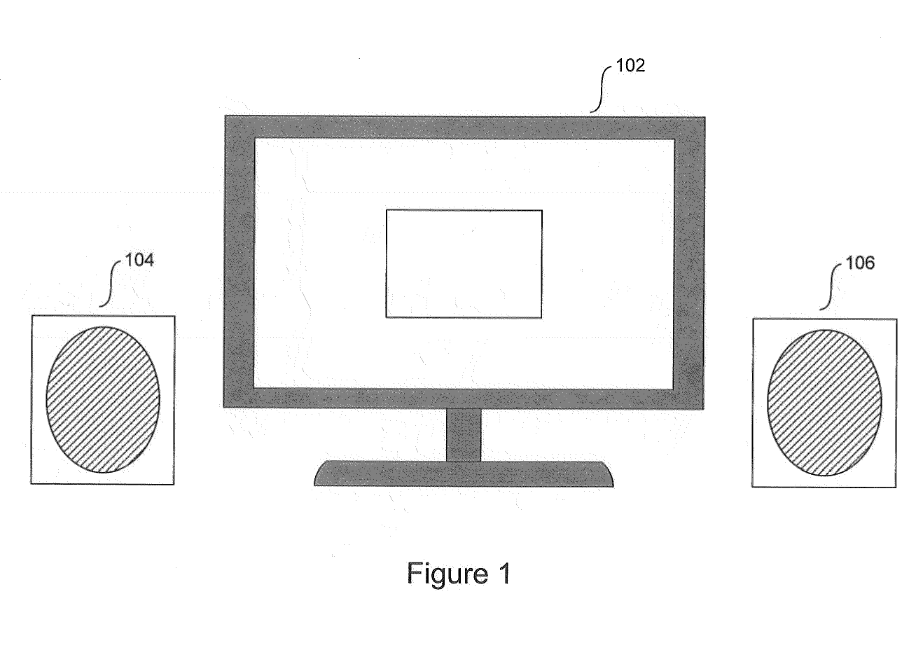

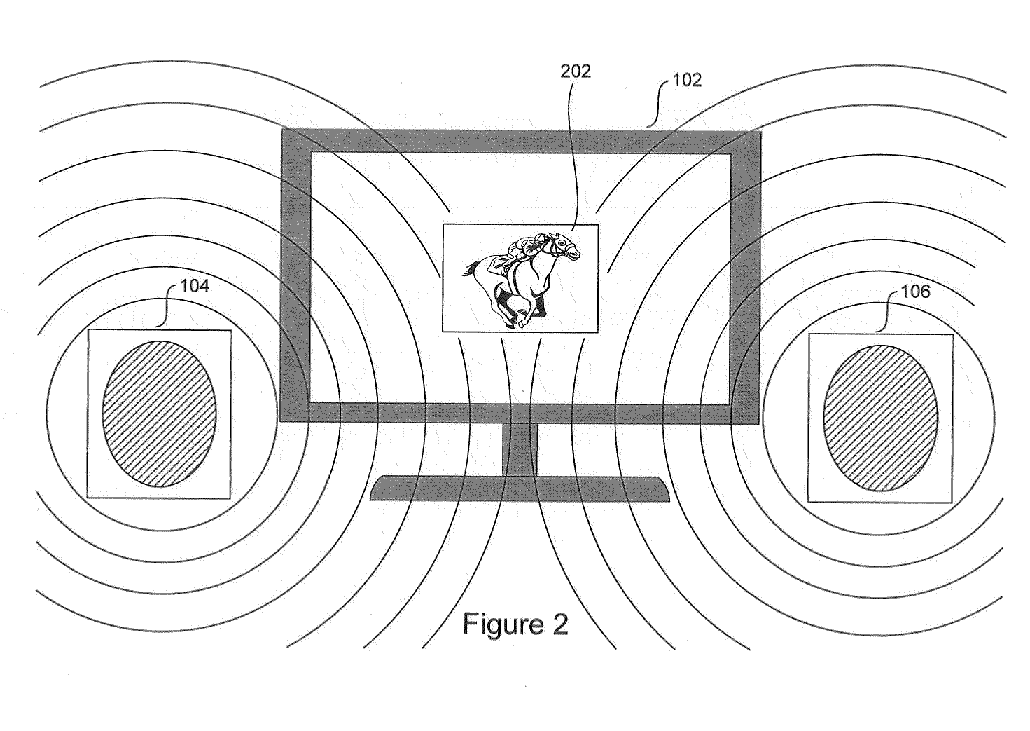

FIG. 1 illustrates a conventional display subsystem provided by a PC or work station. The display subsystem includes a video display screen 102 and a pair of loudspeakers 104-105. FIG. 2 illustrates rendering, to a user or viewer, a single video data stream on the display subsystem shown in FIG. 1. A video data stream is rendered by simultaneously displaying the sequence of video frames within a video-display frame 202 that constitutes the entire area, or some portion of the area, as shown in FIG. 2, of the video display screen 102 and broadcasting the rendered audio signal as left and right stereo-audio signals on the left 104 and right 106 loudspeakers. The stereo audio signals provide spatialization in one dimension, namely across a horizontal dimension in the plane of, and parallel to, an imaginary axis including both ears of a viewer or user. A user or viewer generally automatically associates the rendered audio signal with the rendered video signal, mentally combining audio and visual perception together to form an overall perceptual experience.

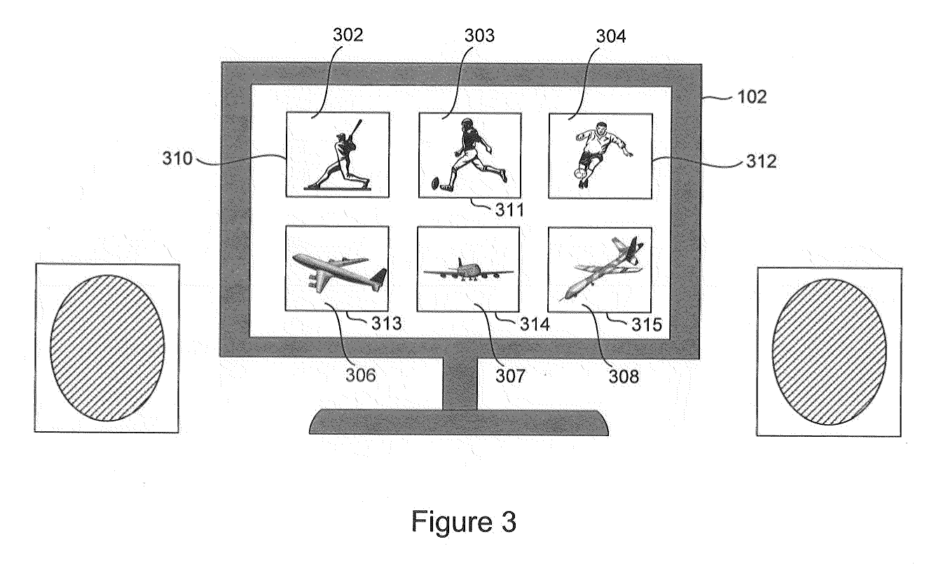

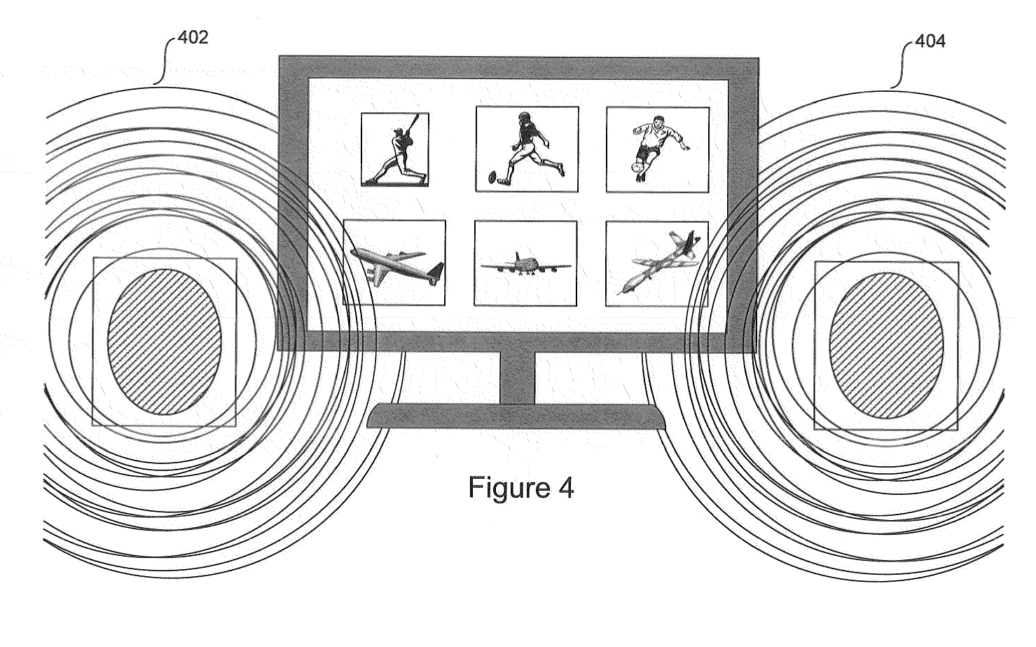

As the capabilities for real-time graphics display and video display of PCs and workstations have increased, application developers have added features and capabilities to multi-media-based applications to take advantage of the increased hardware and systems capabilities of PCs and workstations. In any number of different video-based applications, for example, it may be desirable to simultaneously display multiple video data streams. FIG. 3 illustrates simultaneous rendering of six different video data streams on the display subsystem shown in FIG. 1. In FIG. 3, three sports-related video signals 302-304 and three aeronautics-related video signals 306-308 are simultaneously displayed on the video screen 102 in six spatially separated; non-overlapping video-display frames 310-315. Modern graphical processing units and specialized graphics busses provide adequate processing capacity and bandwidth for simultaneous rendering of multiple video data streams on the display screen. However, currently, the audio signals of all of the simultaneously rendered videos can only be linearly combined together to provide two stereo signals. FIG. 4 illustrates rendering of the combined stereo audio signals of six simultaneously rendered video data streams on the display subsystem shown in FIG. 1. As illustrated in FIG. 4, the combined audio signals 402 and 404 are generally an uninterpretable jumble of the separate audio signals of the six simultaneously rendered video data streams. Unfortunately, each of the two stereo audio signals is one dimensional, so that a combination of six different audio signals together to produce a single, resultant, combined audio signal produces a dense, largely undifferentiated and indecipherable overlapping of the individual audio signals when rendered to a user or viewer. The combination of audio signals in this fashion is analogous to simultaneous rendering the video signals of all of the simultaneously rendered video data streams together in a single video-display frame. In that case, a user or viewer would be unlikely to discern any meaningful information from the single video-display frame. Separate display of the multiple video signals of the simultaneously rendered video data streams is possible because the video-display screen is two dimensional, allowing for spatial separation of multiple video-display frames, and the graphics processing units and advanced graphics busses within PCs and workstations provide the computational and data-transfer bandwidths to allow individual video signals to be simultaneously rendered in each of the spatially separate video-display frames. Currently, audio signals are not correspondingly processed for perceived spatial separation.

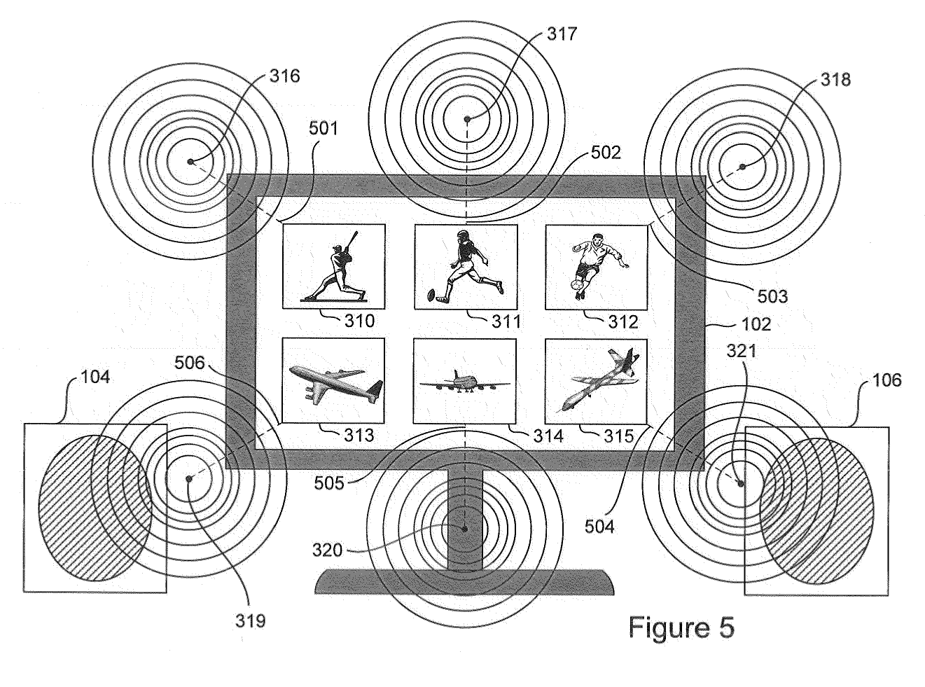

Method and system embodiments of the present invention employ spatialization techniques to process the audio signals of each of a set of simultaneously displayed video data streams in order that a viewer or user perceives each individual audio signal of a particular video data stream, when rendered through loudspeakers or headphones, as emanating from a different point in three-dimensional space correlated with the relative position of the video-display frame in which the video signal of the particular video data stream is visually displayed. FIG. 5 illustrates simultaneous rendering of multiple video data streams, according to one embodiment of the present invention, on the display subsystem shown in FIG. 1. As shown in FIG. 5, for each video-display frame 310-315, a corresponding location in space 316-321 is selected as a point in space from which the audio signal corresponding to the video signal rendered in the video-display frame should be perceived by a user or viewer to emanate from, when rendered through the loudspeakers. In other words, the audio signal of each video data stream is separately processed so that, when rendered through the two loudspeakers 104 and 105, the rendered audio signal is perceived by a user or listener to emanate from the position of the selected positions 316-321 corresponding to the spatial position of the video-display frame in which the corresponding video signal is displayed. In the embodiment shown in FIG. 5, the selected points 316-321 are offset from, but in the same plane as, the spatial locations of the video-display frames. However, in alternate embodiments, the apparent sources of the rendered audio signals may be staggered in depth, or in a dimension perpendicular to the plane of the video display screen 102, to provide further spatial separation. It is also possible, in alternative embodiments of the present invention, that visual techniques may be used to make it appear that a first video-display frame overlies, but is closer to the viewer than, a second video-display frame, in which case the selected points from which the rendered audio signals for the two video-display frames are perceived to emanate from are spatially differentiated in a depth direction, or direction approximately normal to the plane of the video-display screen. Many other methods for spatially rendering video, signals simultaneously from multiple video data streams may be employed, and, in all cases, according to embodiments of the present invention, the individual audio signals are spatially processed so that the individual audio signals appear to emanate from points in three-dimensional space correlated with the spatial locations of the individual video-display frames.

Next, one technique for spatialization of an audio signal is described. The described technique employs head-related impulse responses (“HRIRs”) and corresponding head-related transfer functions (“HRTFs”). There are additional techniques that can be used separately, or in combination with the described techniques, for spatialization of an audio signal, including audio analogs to visual ray tracing. In older audio systems, spatialization was attempted merely by controlling the amplitude of the audio signal input to each speaker of a set of speakers. In these systems, were the audio signal input to an upper-right-hand speaker of a four-speaker system to have an amplitude several times greater than the amplitude of the same audio signal input to the remaining three speakers of the four-speaker system, the sound source might be perceived as coming form a direction above and to the right of the listener. However, this crude, volume-only spatialization is carried out by simply varying the amplitudes of an analog signal output to different speakers. Each speaker receives the same audio signal, except that the amplitude of the audio signal may vary from one speaker to the next. By contrast, the currently described method and system employs spatially processing of digitally-encoded audio signals that produces, for each digitally-encoded audio signal, a set of different spatially processed audio signals, one spatially processed audio signal for each speaker or other audio-signal-rendering device of a audio-broadcast subsystem. Amplitude differences may occur between the different spatially processed audio signals of a set of different spatially processed audio signals. However, other differences between the different spatially processed audio signals also occur, so that each speaker or other audio-signal-rendering device receives a different audio signal, and not just an audio signal that may differ only in amplitude from the same audio signal output to another speaker, as in the older, volume-only spatialization methods.

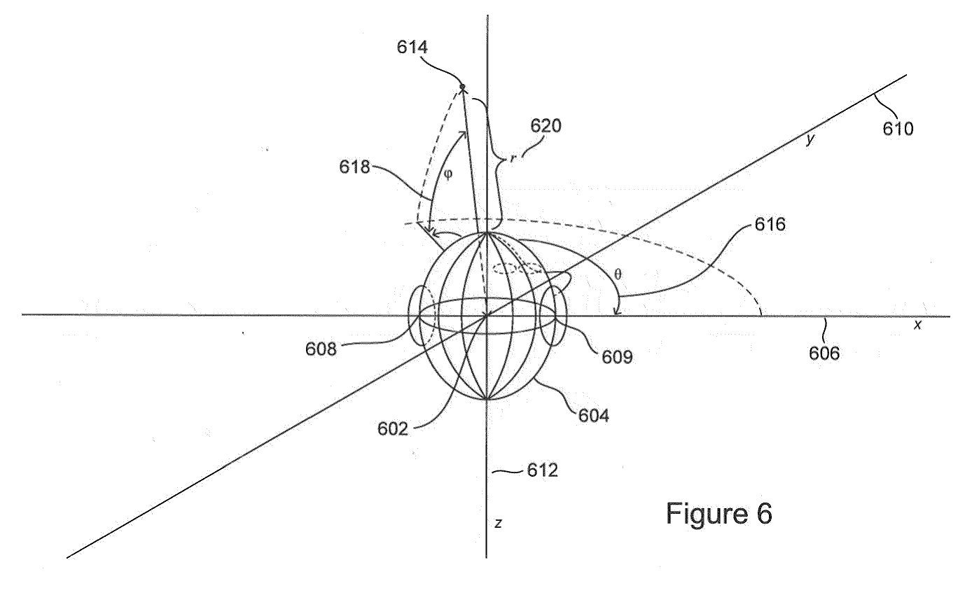

Humans can generally discern the approximate spatial location of the source of any particular sound. In discussing these spatial capabilities, it is convenient to rely on a spatial coordinate system relative to a user's or listener's head. FIG. 6 shows a coordinate system often employed in the audio-spatialization-related literature. An underlying Cartesian x,y,z coordinate system is centered halfway between the cars 602 of a user or viewer 604. The x axis 606 runs through the center of both ears 608-609. The y axis 610 is perpendicular to the x axis, with positive direction extending forward from the center of a user or listener's face. The z axis 612 is perpendicular to both the x and y axes. The position of a particular source 614 from which sound is emitted is specified using spherical coordinates. The spherical coordinates for the source 614 shown in FIG. 6 include an angle θ 616 that the x,z plane would need to be rotated in order to bring the source into the x,z plane, the angle γ 618 is the angle that the rotated x axis would need to be rotated in order that the x axis be coincident with the source, and the distance r 620, or radial distance from the origin 602 to the source 614. The angle θ is referred to as the “azimuth” or “azimuth angle,” the angle φ is referred to as the “elevation” or the “elevation angle,” and the distance r is referred to as the “range.” In general, the types of audio cues employed by humans that facilitate the spatial locations of the source of sounds fall into cues for discerning the azimuth angle, cues for distinguishing the elevation angle, and cues for distinguishing the range of the audio source.

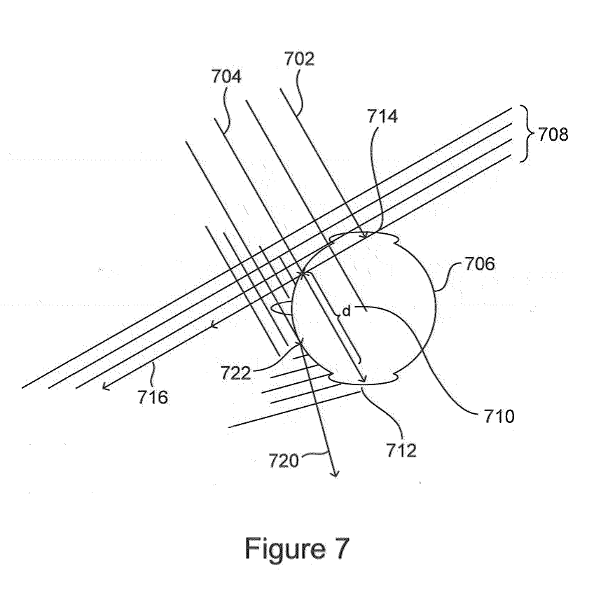

FIG. 7 illustrates azimuth-angle-related audio cues that facilitate determination, by human listeners, of the azimuth angle of a sound source. In FIG. 7, sound from a source is traveling in a direction represented by arrows 702 and 704 towards a user or listener 706. The sound can be visualized as a parallel set of wave fronts 708 traveling in the direction of arrows 702 and 704. As shown in FIG. 7, a wave front must travel an additional distance d 710 to reach the user's left ear 712 compared to the distance that the sound travels to reach the user's right ear 714. When the frequency of the sound is sufficiently high that the wave fronts are separated by distance less than the diameter of the user's head, as shown in FIG. 7, the distance d is not simply related to a phase-angle distance between successive wave fronts. In this case, the time delay of a wave front reaching the user's distal ear with respect to a wave front reaching the user's proximal ear is of little usefulness as a cue for azimuth angle. However, in the case of lower-frequency sound waves, in which the distance between wave fronts is approximately equal to, or greater than, the diameter of the user's head, the time delay represented by distance d in a wavefront reaching the distal ear is linearly related to the phase difference between the sound impinging on the right and left ears, and therefore provides a good indication of the azimuthal angle of the sound source. Another azimuthal cue is the difference in energy, or power, of an audio signal impinging on the right and left ears. As shown in FIG. 7, the right ear 714, being proximal to the sound source, receives direct, unreflected, undiffracted, and unabsorbed wave fronts from the sound source. However, the left ear 712 resides, with respect to the sound source, in an audio shadow created by the user's head. As shown in FIG. 7, the sound waves, when striking the user's head, such as the sound wave traveling along arrow 704, may be reflected or diffracted in various directions, such as in direction 716 by reflection from the point 718 and in direction 720 when reflected from the point 722. A portion of the impinging sound waves reflected from, diffracted by, and absorbed by the user's head results in attenuation of the impinging sound signal, in turn resulting in the sound signal having significantly less energy, or power, in an ear located within an audio shadow. This head-induced-audio-shadow phenomenon is most pronounced with respect to high-frequency, or short-wavelength, sounds and is much less noticeable with respect to lower-frequency, longer-wavelength sounds. Thus, the head-shadow azimuthal cue complements the azimuthal cue resulting from the difference in path length between the two ears of sound emanating from an external source.

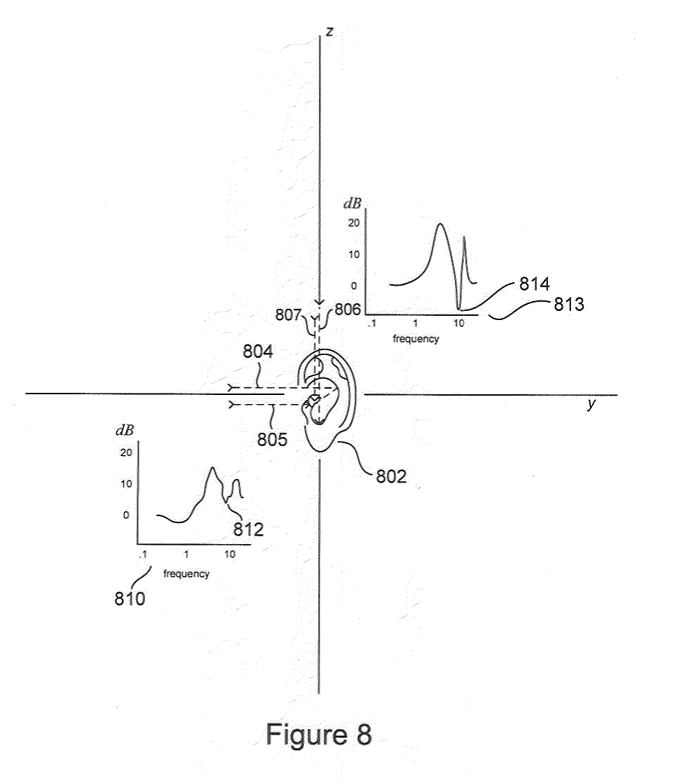

FIG. 8 illustrates one source of elevation-angle-related audio cues that allow a human listener to determine the elevation angle of a sound source. FIG. 8 shows a user's or listener's ear 802 in the coordinate system discussed with reference to FIG. 6. The exterior portions of a human ear have a complex shape that is asymmetrical with respect to they and z axes. As shown in FIG. 8 by dashed arrows 804-805, impinging sound waves traveling in a horizontal direction, parallel to the y axis, may directly enter the ear canal via path 805 or may reflect from the back of the ear into the ear canal via path 804. Similarly, sound waves traveling in a vertical direction, represented by dashed arrows 806 and 807, may also enter the ear canal directly, in the case of path 807, or may reflect from the lower portion of the exterior ear into the ear canal, via path 806. The path lengths for reflected waves differ for sounds waves traveling in vertical and horizontal directions. The differences in path lengths, in the case of horizontal and vertical sound waves, essentially cause the human hearing system to provide a different frequency response for horizontal and vertical sound sources. In FIG. 8, the frequency response for the horizontal sound source 810 appears essentially bimodal, with a relatively shallow valley 812 between two peaks, while the frequency response for a vertical sound source 812, also bimodal, has a relatively deep valley 814 between the two peaks. Difference in frequency response to elevation provides one type of elevation audio cues to human listeners. In fact, the frequency response changes continuously with elevation angle, providing one source of elevation-angle cues to human listeners.

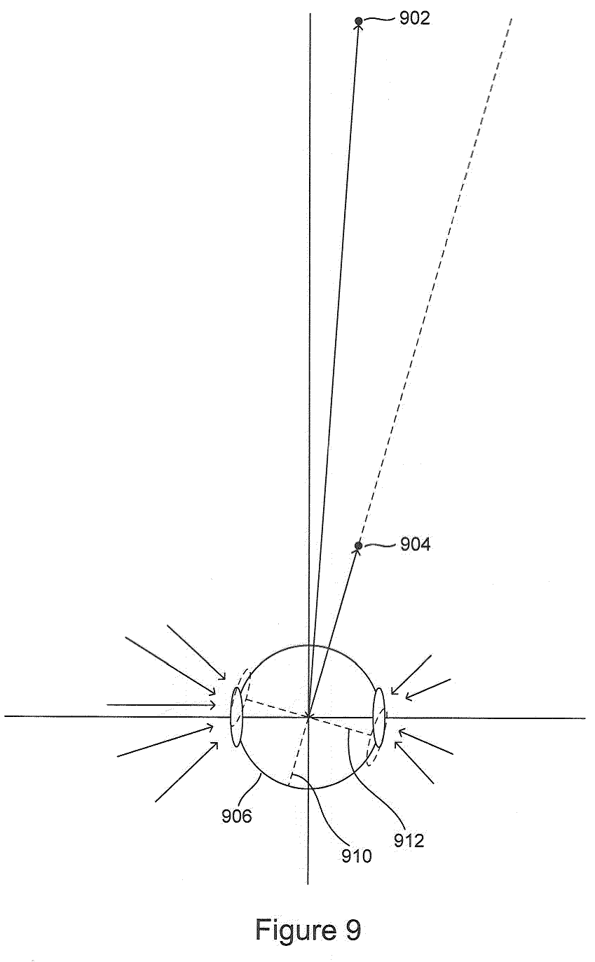

FIG. 9 illustrates range-related audio cues that allow a listener to determine the distance to a sound source. In FIG. 9, two sound sources 902 and 904 are shown relative to a listener's head 906. One important range cue is that the intensity of sound impinging on an ear is inversely related to the square of distance of the sound source from the ear. Thus, the intensity of sound waves falls off exponentially with distance, and loudness is therefore one important range-related audio cue. However, because sound sources have different intrinsic source intensities, or volumes, the intensity cue, by itself, is generally insufficient. Another range cue is analogous to parallax in vision. When a listener slightly turns his or her head about the z axis, indicated in FIG. 9 by the dashed axes 910 and 912, the azimuthal effects discussed with reference to FIG. 7 are far more pronounced for a near source 904 than for a far source 902. A third audio cue is the ratio between loudness of direct sound and the loudness, or intensity, of reflected or reverberations. As discussed above, the intensity of direct sound falls off exponentially with distance. However, in many situations, reflected sound is reflected from many different points in a listener's environment, and therefore remains relatively constant, in intensity, regardless of distance of the source from the listener. Thus the ratio of direct sound to reflected sound may provide a useful audio cue with regard to the distance of the source of the sound from a listener.

Many additional audio cues may be used by human listeners. For example, a human's torso and shoulders provide differential reflection and absorption of sound waves. Furthermore, listeners naturally correlate sound with visual clues. While there may be many additional audio clues employed by human listeners, a sufficient number of conceptual clues are understood to enable a rational approach to processing audio signals in order to cause the signals, when rendered to a user of a multi-media-rendering application or device, to be perceived by the user as emanating from an arbitrary point in three-dimensional space.

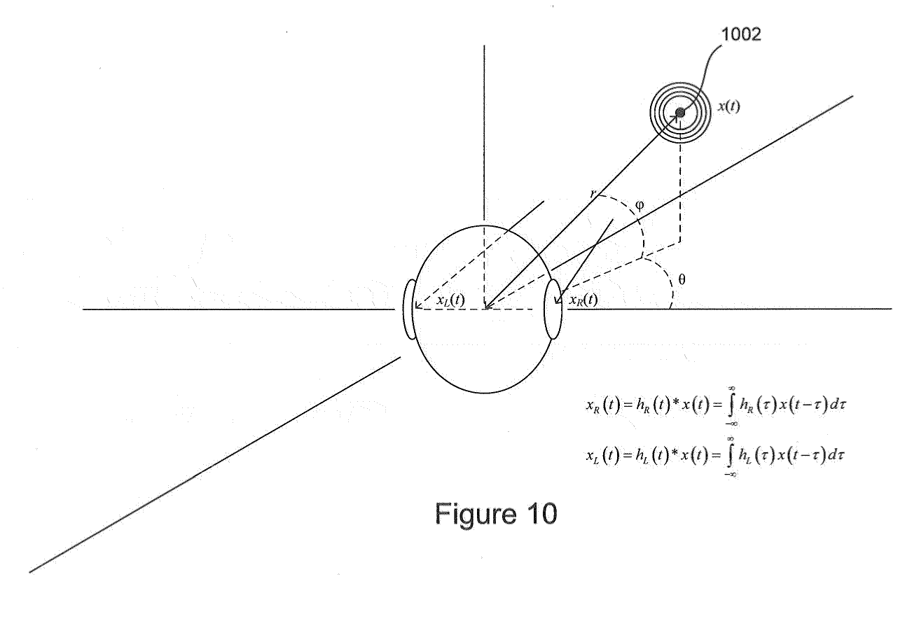

Mathematically, a monaural audio signal can be transformed to include various types of audio cues, such as those discussed with reference to FIGS. 6-9, in order to generate a perception, on behalf of a user listening to the rendering of the processed audio signal, that the source of the audio signal is located at a particular point in three-dimensional space. FIG. 10 illustrates spatial transformation of a monaural audio signal to produce left and right signals that, when rendered through headphone speakers, is perceived by a listener to emanate from a selected point in three-dimensional space. In FIG. 10, a monaural audio signal x(t) is known. A mathematical transformation of this signal is desired so that the source of sound x(t) 1002 is perceived by a listener to be located at position (θ, φ, r) in three-dimensional space with respect to the listener. The monaural sound signal x(t) can be processed to generate a right-ear signal x_{R}(t) and a left-ear signal x_{L}(t). The right-ear and left-ear signals x_{R}(t) and x_{L}(t) may be, for example, output from the right and left speakers of a headset or from left and right speakers of a computer speaker system. Different processing is needed for headphone signals than for speaker-system signals, since speaker-system signals are located at a significant distance from the ears, and both ears are generally capable of hearing sound output by both speakers. In general, the right and left signals can be mathematically computed as the convolution of the monaural signal with a head-related-impulse response (“HRIR”), as expressed by:

$${x}_{R} ( t ) = {h}_{R} ( t ) * x ( t ) = {\int }_{- ∞}^{∞} {h}_{R} ( τ ) x ( t - τ ) d τ$$

$${x}_{L} ( t ) = {h}_{L} ( t ) * x ( t ) = {\int }_{- ∞}^{∞} {h}_{L} ( τ ) x ( t - τ ) d τ$$

where

h_{R}(t) is the right-ear HRIR;

h_{L}(t) is the left-ear HRIR;

τ is a variable of integration; and

t is time.

Thus, when the HRIR for both cars can be estimated, computed, or empirically derived, then a monaural sound source can be processed so that the sound source appears to emanate from a selected point in three-dimensional space. The HRIR is dependent on the rendering system, the listener, and the selected point in space from which the sound is to be perceived as emanating from.

In general, it is easier to carry out the convolution, expressed in the above expressions, in frequency space. A Fourier transform of the source signal x(t) can be used to generate a corresponding frequency-domain signal X(f):

$$X ( f ) = {\int }_{- ∞}^{∞} x ( t ) {e}^{- i 2 π f t} d t$$

where f=frequency; and

t=time.

The square of the magnitude of the frequency-domain signal X(f) at frequency f is related directly to the energy of the signal at frequency f:

|X(f)|²∝energy of signal at f

One can regenerate the time-domain signal x(t) from the frequency-domain signal X(f) by a reverse Fourier transform:

$$x ( t ) = {\int }_{- ∞}^{∞} X ( f ) {e}^{- i 2 π ft} d f$$

The Fourier transform of the HRIR generates a corresponding head-related transfer function (“HRTF”)

$${H}_{R} ( f ) = {\int }_{- ∞}^{∞} h ( t ) {e}^{- i 2 π ft} d t$$

By the convolution theorem, the right-ear and left-ear processed signals x_{R}(t) and x_{L}(t) can be generated either by the above-described convolution or by a reverse Fourier transform of the product of the HRTF and frequency-domain signal X(f), as follows:

$${x}_{R} ( t ) = {h}_{R} * x ( t ) = {\int }_{- ∞}^{∞} {H}_{R} ( f ) X ( f ) {e}^{i 2 π ft} d f$$

$${x}_{L} ( t ) = {h}_{L} * x ( t ) = {\int }_{- ∞}^{∞} {H}_{L} ( f ) X ( f ) {e}^{i 2 π fd} d f$$

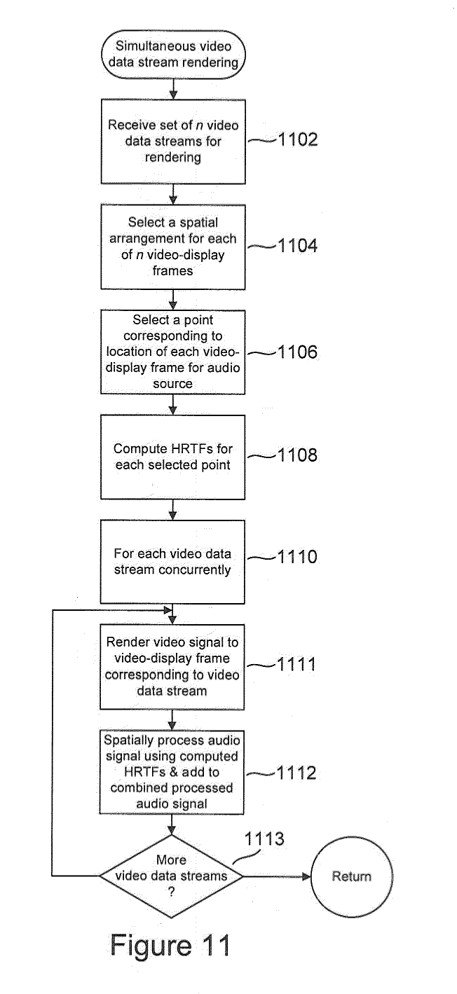

FIG. 11 provides a control-flow diagram for a simultaneous-video-data-stream-rendering routine that represents one embodiment of the present invention. In step 1102, the routine receives a set of n video data streams for rendering. In step 1104, the routine selects a spatial arrangement for the n video-display frames in which each video signal of each video data stream is to be rendered. Various algorithms can be used for determining a pleasing and efficient spatial arrangement, such as algorithms that provide a most widely dispersed arrangement of video-display frames under constraints related to the area of the video display screen and desired areas of the video-display frames. Next, in step 1106, the routine selects a point in space corresponding to the location of each video-display frame for an audio source corresponding to the video-display frame. The points may correspond to the centers of the video-display frames, or may be offset from the locations of the video-display frames to exaggerate the spatial separation of the individual audio sources. As discussed above, video sources may be placed within a single plane, or may be separated both in depth as well as in azimuth and elevation. Next, in step 1108, the routine computes HRTFs for the left and right ears of a user or listener for each of the selected audio-source points. Generation of the HRTFs is, in general, a difficult step. HRTFs can be selected from among a set of standard, pre-computed HRTFs, or may be generated from pre-computed individualized HRTFs obtained in a training step executed prior to rendering of video data streams. Next, in the for-loop of steps 1110-1113, the routine concurrently renders each of the video data streams, during the video signals for display in each of the corresponding video-display frames, spatially processing each of the audio signals using the HRTFs computed in step 1108 and combining all of the processed audio signals together for output to headphone speakers or loudspeakers. Spatial processing may be carried out prior to digital-to-analog conversion, using discrete Fourier transforms, or other similar discrete transforms, or may be carried out on the analog signal, following digital-to-analog conversion, using continuous Fourier transforms or other transforms.

Spatial audio processing can be implemented in software for execution on any of a large variety of general propose and special purpose processors. Alternatively, all or a portion of the spatial audio processing can be carried out by one or more digital signal processors configured to carry out spatial audio processing, including any of various commercially-available digital signal processors configured to carry out spatial audio processing.

Although the present invention has been described in terms of particular embodiments, it is not intended that the invention be limited to these embodiments. Modifications within the spirit of the invention will be apparent to those skilled in the art. For example, the method and system embodiments of the present invention for simultaneous rendering of multiple multi-media presentations may be implemented in software, firmware, hardware circuits, or a combination of software, firmware, and hardware, on a variety of different system and device platforms for incorporation into any number of different multi-media presentation-based applications and/or devices. Computer systems employing any of many different processor and subsystem architectures, operating systems, specialized microprocessors, display components, broadcast components, and other hardware, software, and firmware components can all serve as platforms for multi-media presentation-based applications that provide simultaneous rendering of multiple multi-media presentations according to embodiments of the present invention. Software and firmware portions of embodiments of the present invention may be implemented in many different ways by varying familiar programming and development parameters, including modular organization, control structures, data structures, variables, and other such parameters. While video data streams are an excellent example of the type of multi-media presentations that may be simultaneously rendered according to the present invention, other types of multi-media presentations may also be so rendered, including slide shows, narrated graphical presentations, and other such multi-media presentations. In addition to HRTF and HRIR-based spatial processing of audio signals, additional processing, such as the audio equivalent to ray tracing or incorporating Doppler effects and other such audio cues, may be employed in alternative embodiments of the present invention in addition to, or instead of, the HRIR and HRTF-based methods discussed above. Either a monaural or stereo audio signal can be processed, by various spatialization techniques, to be perceived, when rendered to a listener, as emanating from a particular, elected point in three-dimensional space. A given audio-broadcast subsystem may include two or more separate speakers or other audio-signal-rendering devices, and the set of different spatially processed audio signals produced from each digitally-encoded audio signal generally includes a number of different spatially processed audio signals equal to the number of separate speakers or other audio-signal-rendering devices included in the audio-broadcast subsystem. Commonly, computer systems are equipped with two speakers, and thus two different spatially processed audio signals are generated from each digitally-encoded audio signal. However, embodiments of the present invention can be applied to audio-broadcast subsystems that include three, four, five, or more audio-signal-rendering devices.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A multi-media presentation system comprising:
two or more digitally encoded data streams that each includes a digitally-encoded audio signal and a digitally encoded visual-display signal;
a visual-display subsystem;
an audio-broadcast subsystem; and
a data-stream processing component that
for each of the two or more digitally encoded data streams, directs the digitally encoded visual-display signal to the visual-display subsystem for display within a visual-display frame corresponding to the digitally encoded data stream, and
processes each digitally-encoded audio signal to produce a set of different spatially processed audio signals that, when rendered to a user through an audio-broadcast subsystem, is perceived by the user as emanating from a particular point in three-dimensional space related to the spatial location of the visual-display frame corresponding to the digitally encoded data stream.

2. The multi-media presentation system of claim 1 wherein, upon receiving n digitally encoded data streams for simultaneous presentation to a user, the processing component:
assigns each of the n digitally encoded data streams to one of n visual-display frames;
selects a spatial arrangement for the n visual-display frames on a display device of the visual-display subsystem;
selects a point in three-dimensional space for a sound source corresponding to each of the n digitally encoded data streams; and
simultaneously, for each of the n digitally encoded data streams
directs the visual-display signal of the digitally encoded data stream to the visual-display frame, assigned to the digitally encoded data stream, on the visual-display subsystem,
processes the digitally-encoded audio signal of the digitally encoded data stream to produce a set of different spatially processed audio signals that, when rendered to the user by the audio-broadcast subsystem, is perceived by the user as emanating from the point in three-dimensional space for the sound source corresponding to the digitally encoded data stream, and
directs the processed audio signal to the audio-broadcast subsystem.

3. The multi-media presentation system of claim 2 further including determining, by the processing component, a pair of head-related impulse responses for each sound source, and processing the digitally-encoded audio signal of each digitally encoded data stream by separately convolving each of the pair of head-related impulse responses with the digitally-encoded audio signal to produce two or more different processed audio signals that are each directed to a separate sound-generating component of the audio-broadcast subsystem.

4. The multi-media presentation system of claim 2 further including determining, by the processing component, a pair of head-related transfer functions for each sound source, and processing the digitally-encoded audio signal of each digitally encoded data stream by transforming the digitally-encoded audio signal to the frequency domain, separately multiplying each of the pair of head-related impulse responses with the transformed digitally-encoded audio signal to produce two or more processed frequency-domain signals, and applying a reverse transform to each of the two or more processed frequency-domain signals to produce two or more corresponding processed time-domain signals that are each directed to a separate sound-generating component of the audio-broadcast subsystem.

5. The multi-media presentation system of claim 2 further including applying an audio analog of ray tracing to the digitally-encoded audio signal of each digitally encoded data stream to generate two or more processed audio signal that are each directed to a separate sound-generating component of the audio-broadcast subsystem.

6. The multi-media presentation system of claim 2 wherein the processing component selects a point in three-dimensional space for a sound source corresponding to each of the n digitally encoded data streams coincident with the spatial location of the visual-display frame corresponding to the digitally encoded data stream on the display device of the visual-display subsystem.

7. The multi-media presentation system of claim 2 wherein the processing component selects a point in three-dimensional space for a sound source corresponding to each of the n digitally encoded data streams spatially related to the spatial location of the visual-display frame corresponding to the digitally encoded data stream on the display device of the visual-display subsystem.

8. The multi-media presentation system of claim 7 wherein a point may be spatially related to the spatial location of a visual-display frame on the display device of the visual-display subsystem by one or more of:
translation in a plane coincident with a plane of the display device;
translation in a direction normal to the plane of the display device.

9. The multi-media presentation system of claim 1 wherein the multi-media presentation system is implemented as one of:
a multi-media application program executing within a PC, workstation, or other computer system; and
a control program within a device that renders multi-media presentations to users.

10. A method for simultaneous presentation, to a user, of n digitally encoded data streams, the method comprising:
assigning each of the n digitally encoded data streams to one of n visual-display frames;
selecting a spatial arrangement for the n visual-display frames on a display device of the visual-display subsystem;
selecting a point in three-dimensional space for a sound source corresponding to each of the n digitally encoded data streams; and
simultaneously, for each of the n digitally encoded data streams
directing the visual-display signal of the digitally encoded data stream to the visual-display frame, assigned to the digitally encoded data stream, on the visual-display subsystem,
processing the digitally-encoded audio signal of the digitally encoded data stream to produce a set of different spatially processed audio signals that, when rendered to the user by the audio-broadcast subsystem, is perceived by the user as emanating from the point in three-dimensional space for the sound source corresponding to the digitally encoded data stream, and
directing the processed audio signal to the audio-broadcast subsystem.

11. The method of claim 10 further including determining a pair of head-related impulse responses for each sound source, and processing the digitally-encoded audio signal of each digitally encoded data stream by separately convolving each of the pair of head-related impulse responses with the digitally-encoded audio signal to produce two or more processed audio signals that are each directed to a separate sound-generating component of the audio-broadcast subsystem.

12. The method of claim 10 further including determining a pair of head-related transfer functions for each sound source, and processing the digitally-encoded audio signal of each digitally encoded data stream by transforming the digitally-encoded audio signal to the frequency domain, separately multiplying each of the pair of head-related impulse responses with the transformed digitally-encoded audio signal to produce two or more processed frequency-domain signals, and applying a reverse transform to each of the two or more processed frequency-domain signals to produce two or more corresponding processed time-domain signals that are each directed to a separate sound-generating component of the audio-broadcast subsystem.

13. The method of claim 10 further including applying an audio analog of ray tracing to the digitally-encoded audio signal of each digitally encoded data stream to generate two or more processed audio signals that are each directed to a separate sound-generating component of the audio-broadcast subsystem.

14. The method of claim 10 further including selecting a point in three-dimensional space for a sound source corresponding to each of the n digitally encoded data streams coincident with the spatial location of the visual-display frame corresponding to the digitally encoded data stream on the display device of the visual-display subsystem.

15. The method of claim 10 further including selecting a point in three-dimensional space for a sound source corresponding to each of the n digitally encoded data streams spatially related to the spatial location of the visual-display frame corresponding to the digitally encoded data stream on the display device of the visual-display subsystem.
